(19) United States
(12) Patent Application Publication
(10) Pub. No.: US 2007/0013240 A1
(43) Pub. Date: Jan. 18, 2007

(54) Stator heat transfer device

(75) Inventors: Anthony J. Aiello, Santa Cruz, CA (US); Paco Flores, Felton, CA (US); Klaus D. Kloeppel, Watsonville, CA (US)

Correspondence Address: SEAGATE TECHNOLOGY c/o MOFO SF, 425 MARKET ST., SAN FRANCISCO, CA, 94105, US

(73) Assignee: SEAGATE TECHNOLOGY LLC, Scotts Valley, CA (US)

(21) Appl. No.: 11/182,211

(22) Filed: Jul. 14, 2005

(51) Int. Cl. H02K 9/00; H02K 7/00; H02K 5/10

(52) U.S. Cl. 310/52; 310/85; 310/90; 310/67 R; 360/98.07; 360/99.07

(57) ABSTRACT

According to one example, a motor including a fluid dynamic bearing system is provided. The motor includes a first stationary member and a second member disposed for relative rotation and a fluid dynamic bearing region disposed therebetween. A stator is disposed with the first member and includes a plurality of stator teeth having a coil of wire wound thereon. A heat transfer device is further included, wherein the heat transfer device transfers heat away from the stator coils toward the bearing region. The transfer of heat may raise the temperature of the bearing fluid, thereby reducing bearing fluid viscosity. The heat transfer device may include one or more air vanes to direct air through, over, or adjacent the stator and/or thermally conductive materials or elements, and may further be incorporated into a flux shield.

### BACKGROUND

1. Field

Various aspects of the present invention relate generally to spindle motors, and in particular, to Fluid Dynamic Bearing (FDB) motors for use in disc drives.

2. Related Art

Magnetic disc drives are well known for magnetically storing information. Broadly speaking, a magnetic disc drive includes a magnetic disc that rotates at high speed as a transducing head “flies” over a surface of the disc. The transducing head records information on the disc surface by impressing a magnetic field on the disc. Information is read back using the transducing head by detecting magnetization of the disc surface. The transducing head is moved radially across the surface of the disc so that different data tracks can be read back.

Over the years, storage density has tended to increase and the size of the storage system has tended to decrease. This trend has led to greater precision and lower tolerance in the manufacturing and operating of magnetic storage discs. For example, to achieve increased storage densities, the transducer head is placed increasingly close to the surface of the storage disc to track ever more densely positioned data tracks.

Additionally, as the storage system size has tended to decrease, the available space for the motor, including the stator and windings used to drive the motor, have decreased accordingly. For example, rotation of a motor may be achieved through a stator that, when energized, communicates with a magnet associated with a rotatable hub, which supports one or more magnetic discs, to induce rotation of the hub and the one or more magnetic discs. The stator generally includes a plurality of “teeth” formed of a magnetic material, where each of the teeth is wound with a winding or wire that when energized creates a torque between the stator and the rotor portion of the motor. The power or torque of the motor depends, at least in part, on the stator size, magnet size, and the number of windings of the wire.

As the available space for the stator and windings decreases with system size, the use of increasingly fine gage wire is generally used to fit an adequate number of winding turns around the stator teeth to produce a desired torque. Increasingly fine gage wire, however, increases the winding resistance, which in turn results in high copper losses (generally equal to the current squared times resistance of the wire). Increased copper losses draw more power and may drain device battery life in an unacceptable amount of time, especially in relatively cold conditions in which the motor current is generally higher due to viscous losses in the motor's fluid dynamic bearing systems(s).

Accordingly, systems and methods for providing a spindle motor, and in particular, an FDB spindle motor, with improved operating characteristics are desired.

### SUMMARY

According to one aspect, a motor including a fluid bearing system is provided. In one example, a motor includes a first stationary motor member and a second motor member disposed for relative rotation and having a fluid bearing region disposed between opposing surfaces of the first and second motor members. A stator is disposed with the first motor member and includes a plurality of stator teeth, each of the stator teeth including a coil of wire wound thereon. A heat transfer device is further included, wherein the heat transfer device is operable to transfer heat away from the stator coils toward the fluid bearing during relative rotation of the first motor member and second motor member. The transfer of heat from the coils toward the first motor member or the second motor member may result in heating the bearing fluid of the motor, thereby reducing the viscosity of the bearing fluid.

In one example, the heat transfer device includes one or more air vanes to direct air through, over, or adjacent the stator to transfer heat via convection. In other examples, thermally conductive materials or elements may be placed adjacent the stator to transfer heat via conduction. Additionally, the heat transfer device may be incorporated into a flux shield disposed axially adjacent the stator.

According to another aspect, a method for transferring heat within a fluid bearing motor is provided. In one example, the method includes activating a stator to cause relative rotation of the stator and a rotor, the stator including stator teeth wrapped with coils of wire. Heat is transferred from the coils of the stator toward a rotor member, thereby heating bearing fluid associated with a fluid bearing of the motor.

Various aspects and examples are better understood upon consideration of the detailed description below in conjunction with the accompanying drawings and claims.

### BRIEF DESCRIPTION OF THE DRAWINGS

For a fuller understanding of examples used herein, reference is made to the accompanying drawings in the following detailed description.

FIG. 1 illustrates a partial schematic view of a magnetic disc drive storage system according to one example;

FIG. 2 illustrates a cross-sectional view of a portion of an exemplary FDB motor including a stator heat transfer device according to one example;

FIG. 3 illustrates a perspective view of a heat transfer device positioned adjacent a stator according to another example; and

FIG. 4 illustrates a perspective view of a heat transfer device positioned adjacent a stator according to another example.

### DETAILED DESCRIPTION

The following description is presented to enable a person of ordinary skill in the art to make and use various aspects of the inventions. Descriptions of specific materials, techniques, and applications are provided only as examples. Various modifications to the examples described herein will be readily apparent to those skilled in the art, and the general principles defined herein may be applied to other examples and applications without departing from the spirit and scope of the inventions. For example, aspects and examples may be employed in a variety of motors, including motors for use in disc storage drives. Motors for disc storage drives may be designed and may operate in a number of ways. The exemplary motors and other exemplary subject matter provided herein are for illustrating various aspects and are not intended to limit the range of motors and devices in which such examples and aspects may be applied.

In one aspect and one example described herein, an exemplary method and system are provided for transferring heat from the stator to the rotor, whereby the temperature of bearing fluid of the motor is increased. In one example, air (or gas) is directed to, over, or adjacent to coils of the motor stator and toward members of the motor, such as the shaft or sleeve, which may include surfaces defining one or more bearing regions (including, e.g., Fluid Dynamic Bearing (FDB) regions) of the motor. In other examples, thermally conductive materials are positioned between stator coils to transfer or communicate heat from the coils to members of the motor. Transferring heat to bearing fluid (or lubricating liquid) of the bearing regions or to members of the motor that include, or are in thermal communication with the bearing fluid, raises the temperature and lowers the viscosity of the bearing fluid. Lowering the viscosity of the bearing fluid generally reduces the power required for a given torque and rotational speed of the motor.

Exemplary FDB motor systems may benefit, for example, from improved thermal compensation of overall motor power losses at relatively cold temperatures and a shortened duration of higher initial power draw from a power source (e.g., a battery). The power dissipated in the winding coils due to copper losses manifests as heat generated, and this heat may be transferred to the rotor by convection and/or conduction where it serves to warm the rotor, thus lowering the viscosity of the bearing fluid and corresponding viscous losses. The lower viscous losses may result in lower running current, which in turn lowers the I²R copper losses and improves device battery life (where I is electrical current in the coils and R is the resistance of the coils).

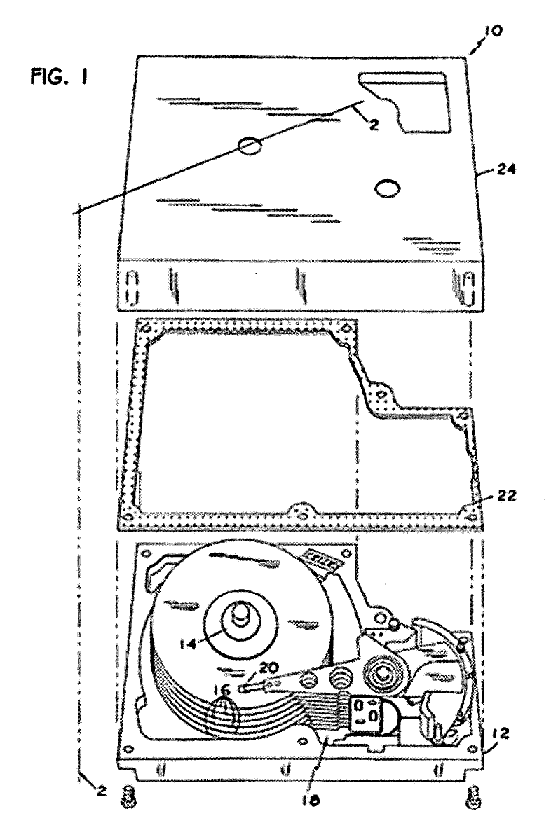

FIG. 1 is an exploded perspective view of a magnetic disc drive storage system in which an exemplary motor including a stator heat transfer device may be used. In this particular example, the storage system 10 includes a housing base 12 having spindle motor 14 which rotatably carries storage discs 16. An armature assembly 18 moves transducers 20 across the surfaces of discs 16. The environment of discs 16 is sealed by seal 22 and cover 24. In operation, discs 16 rotate at high speed while transducers 20 are positioned at any one of many radially differentiated tracks on the surface of the discs 16. This allows the transducers 20 to read and write magnetically encoded information on the surfaces of discs 16 at selected locations as the discs rotate beneath the transducers 20. Because spindle motor 14 rotatably supports discs 16, spindle motor 14 includes at least one low friction rotatable portion that is supported by one or more fluid dynamic bearing surfaces.

The general configuration and arrangement of storage system 10 shown in FIG. 1 is illustrative only, and other arrangements of the various components have frequently been used, and aspects provided are not limited by the particular configuration of disk drive 10 shown.

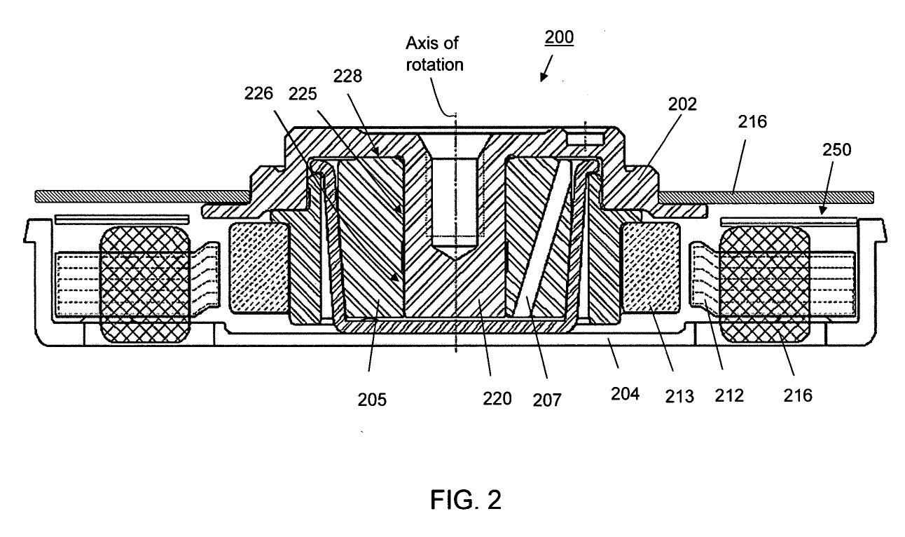

FIG. 2 illustrates a portion of an exemplary spindle motor 200 including a stator heat transfer device 250 according to one example. In this example, motor 200 generally includes a rotor portion, including shaft 220 and hub 202, which rotate relative to a stationary portion of motor 200, including sleeve 205 and stator 212 fixed with respect to base 204. Shaft 220 and hub 202 may be a single piece (as shown) or include multiple sections fixed together. At least one disc 216 is further mounted to hub 202 for rotation.

An inner radial surface of sleeve 205 and outer radial surface of shaft 220 form a gap therebetween, which includes a lubricating liquid or bearing fluid during operation. One or both of the radial surfaces may include circumferentially disposed groove regions 225 and 226 where groove region 225 and/or groove region 226 may be asymmetrical and may function to circulate lubricating liquid through portions of motor 200, e.g., recirculation channel 207. A groove region 228 may further be formed between and end surface of sleeve 205 and hub 202 to form a thrust bearing, for example. Various other groove regions may be formed between opposing motor members as will be recognized by those of ordinary skill in the art.

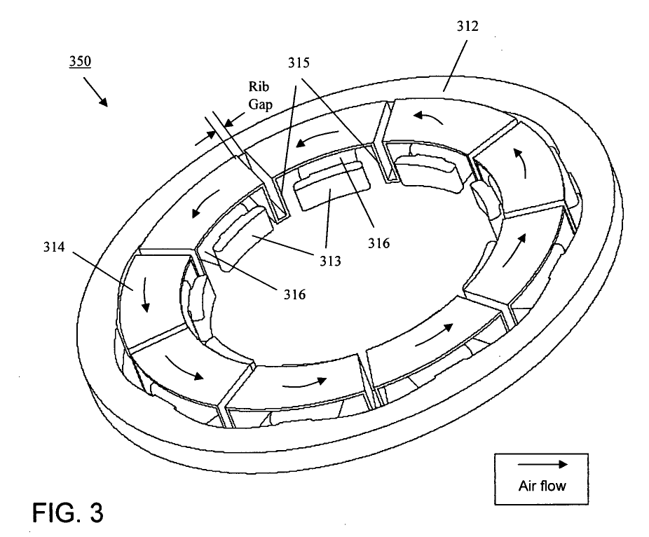

Mounted with sleeve 205 and base 204 is a stator 212 that, when energized, communicates with a magnet 213 associated with hub 202 and induces rotation of hub 202 and stationary shaft 220 relative to sleeve 205. Stator 212 includes plurality of “teeth” (see, e.g., teeth 313 as shown in FIG. 3) formed of a magnetic material, where each of the teeth is wound with a winding or wire coil 216.

Additionally, motor 200 includes stator heat transfer device 250. In this example, stator heat transfer device 250 is incorporated with a flux shield (not separately indicated) of motor 200, which is disposed adjacent stator 212. In other examples, motor 200 may include a conventional flux shield in addition to a heat transfer device 250. Further, stator heat transfer device 250 is shown disposed axially between stator 212 and a relatively rotational portion of motor 200, e.g., hub 202 and/or magnetic disc 216 disposed with hub 202, and is operable to transfer heat inward toward an inner radius of stator 212.

Heat transfer device 250 operates through conduction and/or convection to transfer heat from coils 216 of stator 212 toward motor members associated with bearing regions of motor 200, e.g., toward sleeve 205, hub 202, shaft 220, and the like. The transfer of heat may be directed to various members of motor 200 to raise the temperature of bearing fluid as it resides in any of a number of locations, for example, bearing regions 225, 226, or 228, recirculation channel 207, fluid reservoirs or capillary seals (not indicated in FIG. 2), or the like.

The transfer of heat from coils 216 to the bearing fluid acts to reduce viscosity of the bearing fluid. Accordingly, power losses associated with high viscosity of the bearing fluid may be reduced. This feature may be particularly advantageous during spin-up or start-up of motor 200 or when operating in relatively cool temperature environments (e.g., below room temperature, approximately 22 degrees Celsius). For example, in applications associated with hard disc drive spindle motors, which may include an ester based bearing fluid in the bearing regions, it may be desirable to transfer heat as described to the bearing region and bearing fluid. The viscosity of exemplary ester based bearing fluids may be substantially reduced by warming the bearing fluid, e.g., from a start-up temperature in the range of −15 to 5° C., to a greater temperature.

In some examples, heat transfer device 250 may include vanes, baffles, openings, or other features or characteristics which operate to direct or allow a flow of air to pass over, by, or through elements of or associated with stator 212 (e.g., coils 216). The flow of air may further be directed toward one or more motor members, thereby transferring heat to motor members via convection. In other examples, heat transfer device 250 may include thermally conductive material or materials (e.g., having a high thermal conductivity similar to or greater than that of copper, aluminum, and the like, compared with low thermal conductivity materials such as air, ceramics, plastics, and the like) to conduct heat away from stator 212 and coils 216 toward motor members, thereby transferring heat via conduction. For example, a structure of one or more conductive elements may be disposed between adjacent teeth of stator 212 and coils 216 and fixed in place, e.g., potted with a thermally conductive adhesive or the like, to conduct heat away from coils 212. Additionally, the heat transfer device may include multiple devices for transferring heat both by convection and conduction, e.g., with conductive elements placed between stator coils as well as a structure for directing airflow between stator coils and/or adjacent the conductive elements and toward motor members.

Additionally, heat transfer device 250 may be separate from and placed adjacent to a flux shield. In one example, a multilayer structure, including a first layer suitable for flux shield purposes (such as magnetic steel or the like) may be disposed adjacent to or bonded to a high thermally conductive material layer (such as copper, aluminum, or the like).

FIG. 3 illustrates one example of a heat transfer device 350 in greater detail. In this example, heat transfer device 350 is incorporated into a flux shield 314 and disposed adjacent a stator 312. Flux shield 314 includes a plurality of unshaped protrusions or ribs 315 extending between adjacent stator teeth 313 such that each coil 316 has a thermally conductive material on three sides (e.g., the top and both sides of coils 316 as viewed in FIG. 3). As coils 316 generate heat during operation it is transferred to flux shield 314 and ribs 315. During relative movement of motor members, circumferential airflow (often referred to as “windage”) is induced by the shearing effect of opposing surfaces. For example, a hub and/or data storage disc (see, e.g., hub 202 and disc 216 of FIG. 2) rotating just above flux shield 314 and stator 312 may create circumferential airflow. An exemplary direction of airflow is shown generally in FIG. 3 by the arrows along flux shield 314. The circumferential airflow cools and transfers heat away from coils 316 at a rate greater than a conventional flux shield absent heat transferring characteristics such as ribs 315.

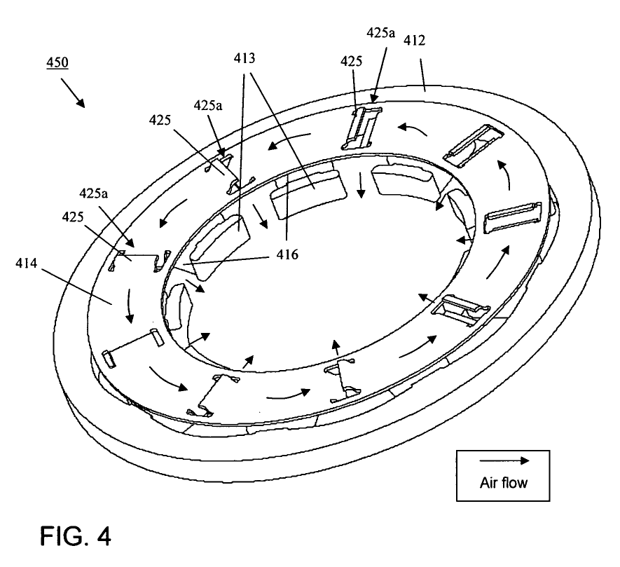

Ribs 315 may also be shaped or disposed in various ways to direct the airflow down through the gaps of ribs 315 and/or inward toward the rotor generally disposed within the inner diameter of stator 312 during operation (see, e.g., the airflow directions shown in FIG. 4). Ribs 315 may be angled, axially or radially, may include vanes, baffles, fins, channels, inlet guides, or the like. Further, flux shield 314 may include a single structure or multiple structures formed adjacent stator 312. For example, multiple ribs 315 or fin shaped elements could be attached to a lower portion of a conventional flux shield 314 to extend between adjacent stator teeth 313. Additionally, ribs 315 could be attached to a structure separate from flux shield 314.

Additionally, ribs 315 could be positioned below or extend from below stator 312. For example, ribs 315 may be attached to or formed integral with a base (see, e.g., base 204 of FIG. 2) of a motor system. It should be noted, however, that the position of ribs 315 should be configured so as to not interfere with the operation of stator 312 or flux shield 314.

Heat transfer device 350 and flux shield 314 may include various thermally conductive materials, including but not limited to metal such as copper, aluminum, or the like. Additionally, flux shield 314, including ribs 315, could be potted or attached directly to stator 312 or stator teeth 313 with an adhesive, e.g., a thermally conductive adhesive such as a zinc oxide filled adhesive or the like. Alternatively, ribs 315 or conductive fins could be potted or attached in place as shown in FIG. 3 separate from flux shield 314 (i.e., without a direct attachment to flux shield 314).

FIG. 4 illustrates another example of a heat transfer device 450 incorporated with a flux shield 414. In this example, flux shield 414 includes a plurality of air vanes 425 disposed adjacent apertures 425a in flux shield 414, which allows airflow through flux shield 414 to stator 412. In particular, a plurality of air vanes 425 are disposed circumferentially around flux shield 414 and generally aligned with gaps between adjacent stator teeth 413. In other examples, apertures 425a and/or air vanes 425 may be at least partially aligned with coil 416 of stator teeth 413.

As previously described, during relative movement of motor members, circumferential airflow is induced by the shearing effect of opposing surfaces. An exemplary direction of airflow is shown generally in FIG. 4 by the arrows along flux shield 414 and directed radially inward from between stator teeth 413. Air vanes 425 are disposed and oriented for a particular direction of relative rotational movement with an opposing surface to direct resulting airflow through flux shield 414 to stator 412, e.g., between adjacent stator teeth 413. Air vanes 425 may further be disposed to direct air to stator 412 and towards a rotor portion of the motor (not shown in FIG. 4) positioned toward the inner diameter of the stator. In other examples, various shaped apertures and air vanes 425 may be included in a variety of manners. Further, apertures may be included in flux shield 414 without air vanes or other means for directing airflow through the apertures.

Additionally, various combinations of elements described with respect to heat transfer device 350 shown in FIG. 3 and heat transfer device 450 shown in FIG. 4 are contemplated. For example, a heat transfer device may include both air vanes or other elements for directing airflow as well as elements disposed between and possibly bonded to coils or portions of the stator to further enhance heat transfer using both convection and conduction as described. Further, multiple heat transfer devices may be employed, e.g., using separate devices on each axial side of the stator, or the like.

This description is exemplary and will be apparent to those of ordinary skill in the art that numerous modifications and variations are possible. For example, various exemplary methods and systems described herein may be used alone or in combination with various FDB systems and methods. Additionally, particular examples have been discussed and how these examples are thought to address certain disadvantages in related art. This discussion is not meant, however, to restrict the various examples to methods and/or systems that actually address or solve the disadvantages.

We claim:

1. A motor including a fluid bearing system, comprising:
a first motor member and a second motor member disposed for relative rotation and having opposing surfaces that form a fluid bearing region, wherein the first motor member is stationary;
a stator disposed with the first motor member and having a plurality of stator teeth, each of the stator teeth including a coil of wire wound thereon; and
a heat transfer device operable to transfer heat from the coils toward the fluid bearing region.

2. The motor of claim 1, wherein the heat transfer device transfers heat to at least one of the first motor member and the second motor member.

3. The motor of claim 1, wherein the heat transfer device is further operable to heat a bearing fluid during relative rotation of the first and second motor members.

4. The motor of claim 1, further including a flux shield, wherein the heat transfer device is at least partially incorporated with the flux shield.

5. The motor of claim 4, wherein the flux shield includes a magnetic steel material and the heat transfer device includes a high thermally conductive material disposed adjacent the magnetic steel material.

6. The motor of claim 4, wherein the flux shield includes one or more air vanes to direct airflow toward the stator.

7. The motor of claim 4, wherein the flux shield includes one or more thermally conductive protrusions disposed between adjacent stator teeth.

8. The motor of claim 1, wherein the heat transfer device includes one or more air vanes to direct airflow toward the stator.

9. The motor of claim 1, wherein the heat transfer device includes one or more air vanes to direct air between adjacent stator teeth.

10. The motor of claim 1, wherein the heat transfer device includes at least one thermally conductive element disposed between adjacent stator teeth.

11. The motor of claim 1, wherein the heat transfer device is attached to the stator by a thermally conductive adhesive.

12. A heat transfer device for a fluid bearing motor system, comprising:
a plurality of members disposed circumferentially around a central axis, wherein
the plurality of members are adapted to be disposed adjacent a motor stator, and
the plurality of members are adapted to transfer heat from the adjacent motor stator toward a fluid bearing.

13. The device of claim 12, wherein at least one of the plurality of members includes an air vane for directing airflow.

14. The device of claim 12, wherein at least one of the plurality of members includes a thermally conducive protrusion and is positionable between adjacent stator teeth.

15. The device of claim 12, wherein the plurality of members are incorporated into a common structure.

16. The device of claim 12, wherein the plurality of members are incorporated into a flux shield.

17. The device of claim 11, wherein the plurality of members include a high thermally conductive material.

18. A method for transferring heat within a fluid bearing motor, comprising:
activating a stator to cause relative rotation of the stator and a rotor, the stator including stator teeth wrapped with coils of wire;
transferring heat from the coils of the stator toward a rotor member, thereby heating bearing fluid associated with a fluid bearing.

19. The method of claim 18, wherein the act of transferring heat includes directing air adjacent to the stator teeth and toward the fluid bearing.

20. The method of claim 18, wherein the act of transferring heat includes conducting heat from between adjacent stator teeth via a thermally conductive material disposed between the adjacent stator teeth.

21. The method of claim 18, wherein the act of transferring heat includes one or more of conduction or convection.
